(19) United States
(12) Patent Application Publication
(10) Pub. No.: US 2016/0205382 A1
(43) Pub. Date: Jul. 14, 2016

(54) METHOD AND APPARATUS FOR GENERATING A LABELED IMAGE BASED ON A THREE DIMENSIONAL PROJECTION

(71) Applicant: Nokia Technologies Oy, Espoo (FI)

(72) Inventors: Xin Chen, Evanston, IL (US); Huang Xinyu, Cary, NC (US)

(21) Appl. No.: 14/592,280

(22) Filed: Jan. 8, 2015

(51) Int. Cl. H04N 13/02; G06T 3/00; G06K 9/62; G06K 9/52; G06K 9/46

(52) U.S. Cl. CPC H04N 13/0275; G06K 9/52; G06K 9/46; G06K 9/6267; G06T 3/00; G06K 2009/4666

(57) ABSTRACT

A method, apparatus and computer program product are provided for generating a labeled image based on a three dimensional (3D) projection. A method is provided including receiving an input image and a 3D shape model associated with an object, generating a 3D projection based on the input image and the 3D shape model, extracting object features associated with a landmark location from the input image, estimating an object position based on the extracted features, determining a distance between a 3D shape landmark location and a true landmark location, applying a regression model based on the extracted feature and the distance between the 3D shape landmark location and the true landmark location, updating the 3D shape model landmark location of the 3D projection based on the regression, and generating a labeled image based on the updated 3D projection.

### TECHNOLOGICAL FIELD

An example embodiment of the present invention relates to object recognition and object analysis and, more particularly, to generating a labeled image based on a three dimensional projection.

### BACKGROUND

Many current image processing applications, such as facial recognition, face tracking, face animation, and three dimensional (3D) face modeling, may require face alignment. Face alignment may be defined as locating object landmarks, such as eye corners, nose tip, or the like, on input images. Face alignment is a fundamental process for many face analysis applications, such as expression recognition and facial animation. The recent increase in personal and web based digital photography has increased the demand for a fully automatic, highly efficient, and robust face alignment method. Facial alignment methods, based on cascaded regression have recently been implanted and become popular on mobile devices. These methods may be accurate and fast, e.g. a few hundred frame per second. However, facial alignment is difficult using current approaches in an unconstrained environment, due to large variations of facial appearance, illumination, and partial occlusions.

### BRIEF SUMMARY

A method and apparatus are provided in accordance with an example embodiment for generating a labeled image based on a three dimensional projection. In an example embodiment, a method is provided that includes receiving an input image and a three dimensional (3D) shape model associated with an object, generating a 3D projection based on the input image and the 3D shape model, extracting object features associated with a landmark location from the input image, estimating an object position based on the extracted features, determining a distance between a 3D shape landmark location and a true landmark location, applying a regression model based on the extracted feature and the distance between the 3D shape landmark location and the true landmark location, updating the 3D shape model landmark location of the 3D projection based on the regression, and generating a labeled image based on the updated 3D projection.

In an example embodiment, the method also includes reperforming the generating, identifying, extracting, estimating, detecting, and applying for at least two iterations. In some example embodiments, the method also includes determining an inconsistent 3D projection and discontinuing possessing of the inconsistent 3D projection. In an example embodiment, the method also includes integrating two or more 3D projections. In some example embodiments of the method, the estimating an object position includes determining a distance between an object position of the 3D projection and a true object position, performing a regression between the extracted features and the distance between the object position of the 3D projection and the true object position, and updating the current position of the 3D projection.

In an example embodiment, the method also includes reperforming the determining the distance between the object position of the 3D projection and the true object position, performing the regression between the extracted feature and the distance between the object position of the 3D projection and the true object position, and updating the object position of the 3D projection for at least two iterations. In some example embodiments, the method also includes identifying occluded landmarks associated with the 3D projection and discontinuing processing of the occluded landmarks.

In another example embodiment, an apparatus is provided including at least one processor and at least one memory including computer program code, with the at least one memory and computer program code configured to, with the processor, cause the apparatus to at least receive an input image and a three dimensional (3D) shape model associated with an object, generate a 3D projection based on the input image and the 3D shape model, extract object features associated with a landmark location from the input image, estimate an object position based on the extracted features, determine a distance between a 3D shape landmark location and a true landmark location, apply a regression model based on the extracted feature and the distance between the 3D shape landmark location and the true landmark location, update the 3D shape model landmark location of the 3D projection based on the regression, and generate a labeled image based on the updated 3D projection.

In some example embodiments of the apparatus, the at least one memory and the computer program code are further configured to reperform the generating, identifying, extracting, estimating, detecting, and applying for at least two iterations. In an example embodiment of the apparatus, the at least one memory and the computer program code are further configured to determine an inconsistent 3D projection and discontinue possessing of the inconsistent 3D projection. In some example embodiments of the apparatus, the at least one memory and the computer program code are further configured to integrate two or more 3D projections. In an example embodiment of the apparatus, the estimating an object position includes determining a distance between an object position of the 3D projection and a true object position, performing a regression between the extracted features and the distance between the object position of the 3D projection and the true object position, and updating the object position of the 3D projection.

In some example embodiments of the apparatus, the at least one memory and the computer program code are further configured to reperform the determining the distance between the object position of the 3D projection and the true object position, performing the regression between the extracted feature and the distance between the object position of the 3D projection and the true object position, and updating the object position of the 3D projection for at least two iterations. In an example embodiment of the apparatus, the at least one memory and the computer program code are further configured to identify occluded landmarks associated with the 3D projection and discontinue processing of the occluded landmarks.

In a further example embodiment, a computer program product is provided including at least one non-transitory computer-readable storage medium having computer-executable program code portions stored therein, with the computer-executable program code portions comprising program code instructions configured to receive an input image and a three dimensional (3D) shape model associated with an object, generate a 3D projection based on the input image and the 3D shape model, extract object features associated with a landmark location from the input image, estimate an object position based on the extracted features, determine a distance between a 3D shape landmark location and a true landmark location, apply a regression model based on the extracted feature and the distance between the 3D shape landmark location and the true landmark location, update the 3D shape model landmark location of the 3D projection based on the regression, and generate a labeled image based on the updated 3D projection.

In an example embodiment of the computer program product, the computer-executable program code portions further comprise program code instructions configured to: reperform the generating, identifying, extracting, estimating, detecting, and applying for at least two iterations. In an example embodiment of the computer program product, the computer-executable program code portions further comprise program code instructions configured to determine an inconsistent 3D projection and discontinue possessing of the inconsistent 3D projection. In some example embodiments of the computer program product, the computer-executable program code portions further comprise program code instructions configured to integrate two or more 3D projections. In an example embodiment of the computer program product, the estimating an object position includes determining a distance between an object position of the 3D projection and a true object position, performing a regression between the extracted features and the distance between the object position of the 3D projection and the true object position and updating the object position of the 3D projection.

In some example embodiments of the computer program product, the computer-executable program code portions further comprise program code instructions configured to reperform the determining the distance between the object position of the 3D projection and the true object position, performing the regression between the extracted feature and the distance between the object position of the 3D projection and the true object position, and updating the object position of the 3D projection for at least two iterations. In an example embodiment of the computer program product, the computer-executable program code portions further comprise program code instructions configured to identify occluded landmarks associated with the 3D projection and discontinue processing of the occluded landmarks.

In yet a further embodiment, an apparatus is provided including means for receiving an input image and a three dimensional (3D) shape model associated with an object, generating a 3D projection based on the input image and the 3D shape model, means for extracting object features associated with a landmark location from the input image, means for estimating an object position based on the extracted features, means for determining a distance between a 3D shape landmark location and a true landmark location, means for applying a regression model based on the extracted feature and the distance between the 3D shape landmark location and the true landmark location, means for updating the 3D shape model landmark location of the 3D projection based on the regression, and means for generating a labeled image based on the updated 3D projection.

In an example embodiment, the apparatus also includes means for reperforming the generating, identifying, extracting estimating, detecting, and applying for at least two iterations. In some embodiments, the apparatus also includes means for determining an inconsistent 3D projection and means for discontinuing possessing of the inconsistent 3D projection. In an example embodiment, the apparatus also includes means for integrating two or more 3D projections. In some embodiments of the apparatus the means for estimating an object position also includes means for determining a distance between an object position of the 3D projection and a true object position, means for performing a regression between the extracted features and the distance between the object position of the 3D projection and the true object position, and means for updating the object position of the 3D projection.

In an example embodiment, the apparatus also includes means for reperforming the determining the distance between the object position of the 3D projection and the true object position, performing the regression between the extracted feature and the distance between the object position of the 3D projection and the true object position, and updating the object position of the 3D projection for at least two iterations. In some embodiments, the apparatus also includes means for identifying occluded landmarks associated with the 3D projection, and means for discontinuing processing of the occluded landmarks.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a communications diagram in accordance with an example embodiment of the present invention;

FIG. 2 is a block diagram of an apparatus that may be specifically configured for generating an aligned three dimensional projection based on a two dimensional image in accordance with an example embodiment of the present invention;

FIG. 3 illustrates an example prior art facial alignment process;

FIG. 4 illustrates an example object alignment process in accordance with an embodiment of the present invention;

FIG. 5 illustrates an example object position alignment process in accordance with an embodiment of the present invention;

FIG. 6 illustrates an example regression forest in accordance with an embodiment of the present invention; and

FIG. 7 is a flow chart illustrating the operations performed, such as by the apparatus of FIG. 2, in accordance with an example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), can be differentiated from a “computer-readable transmission medium,” which refers to an electromagnetic signal.

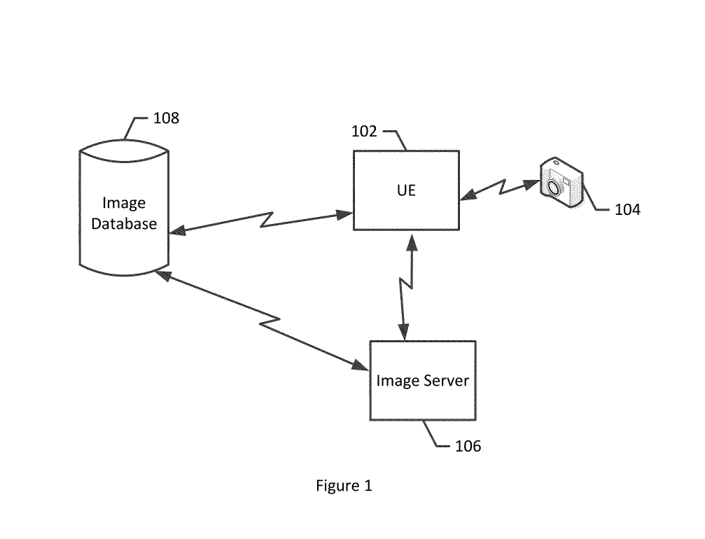

A method, apparatus and computer program product are provided in accordance with an example embodiment for generating a labeled image based on an aligned three dimensional projection. FIG. 1 illustrates a communication diagram including user equipment (UE) 102, in data communication with a camera 104, an image server 106, and/or an image database 108. The UE 102 may include or otherwise be associated with the camera 104. The UE 102 or image server 106 may include the image database 108, such as an image data memory, or be associated with the image database 108, such as a remote image data server. The UE 102 may be a mobile computing device such as a laptop computer, tablet computer, mobile phone, smart phone, navigation unit, personal data assistant, or the like. Additionally or alternatively the UE 102 may be a fixed computing device, such as a personal computer, computer workstation, kiosk, office terminal computer or system, or the like. The image server 106 may be one or more fixed or mobile computing devices. The image server 106 may be in data communication with the image database 108 and/or one or more UEs 102.

The UE 102 or image server 106 may receive a two dimensional image from the image database 108 and/or camera 104. The image may be a still image, a video frame, or other image. In an example embodiment, the UE 102 may store an image in a memory, such as the image database 108 for later processing. The two dimensional image may be any two dimensional depiction of an object, such human face or inanimate object. The UE 102 or image server 106 may also receive a three dimensional (3D) shape model associated with the object. The 3D shape model may be a mean shape based on an approximation of average measurements associated with the object class, for example average face dimensions. The 3D shape model may be received from a memory, such as the image database 108.

The UE 102 or image server 106 may generate a 3D projection based on the 2D image and the 3D mean shape. The UE 102 or image server 106 may normalize the image by adjusting the size of the image to match the 3D shape model size. The UE 102 or image server 106 may apply the 2D image to the 3D shape model by overlaying the 2D image onto the 3D shape model. In some example embodiments, the UE 102 or image server 106 may determine at least one object landmark of the 2D image and apply the 2D image to the 3D shape model based on the determined landmark. A landmark may be any geometrically significant point of an object, such as the corners of eyes or mouth, sides of a nose, eyebrows, or the like of a human face. In an example embodiment, the 3D shape model may be projected onto the 2D image. The UE 102 or image server may minimize the distance between one or more visible landmarks from the 2D image and the landmarks of the 3D shape model. For example, the 2D image and 3D shape model may be aligned, such that a minimum distance is obtained for all visible landmarks.

The UE 102 or image server 106 may identify occluded landmarks, e.g. landmarks associated with the 3D shape model which do not appear in the 2D image. The occluded landmarks are removed from further processing determinations, due to their lack of correlation between the 2D input image and the 3D shape model.

The UE 102 or image server 106 may extract features from the 2D image and generate a feature vector for each feature. In an example embodiment, the feature detection may be individual pixels based on the intensity and location of the pixel. Additionally or alternatively, the feature detection may be edge detection, corner detection, blob detection, ridge detection, scale-invariant feature transform, edge direction, changing intensity, autocorrelation, thresholding, blob extraction, template matching, Hough transform, active contours, parameterized shapes, or the like. The features may be associated with a landmark of the 3D projection.

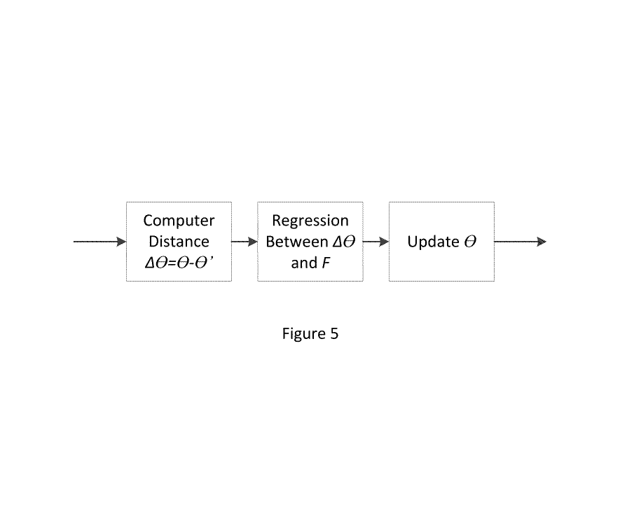

The UE 102 or image server 106 may estimate an object position. The object position may be the position of the object relative to the camera observation. For example, if the object, such as a human face, is looking directly at the camera the object position may be 0 degrees. In an instance in which the object in the input image is askew, the object pose may be one or more angles representing the divergence from a relative center, such as 30 degrees up, 10 degrees left, and 15 degrees clockwise rotation. In this example, the face may be tilted up 30 degrees, looking left 10 degrees, and cocked 15 degrees in a clockwise rotation from the relative center camera observation point. In an example embodiment, the object position estimate may start at 0 degrees in all directions and be aligned by iteration as discussed in FIG. 5 below.

In some example embodiments, the object position may be approximated based on the landmarks identified in the input image and then iteratively aligned to further refine the object position.

The UE 102 or the image server 106 may determine the distance between a 3D shape model landmark location and a true landmark location. The true location may be manually entered by a user, such as during a training stage, or be a predicted landmark location based on machine learned true landmark locations.

The UE 102 or the image server 106 may apply a regression model, such as a non-parametric regression, regression tree, or the like based on the difference between the 3D shape model landmark location and the true landmark location and the extracted feature. Based on the regression the UE 102 or the image server 106 may update the 3D shape landmark location of the 3D projection.

The UE 102 or image server 106 may reperform the process for multiple iterations. Each iteration may reduce the distance between the 3D shape model landmark location and the true landmark location. In some example embodiments, the process may be iterated a predetermined number of times, such as 3, 5, 10, or any other number of iterations. In an example embodiment, the UE 102 or image server 106 may compare the distance between the 3D shape model landmark location and the true landmark location to a predetermined threshold. In an instance in which the distance satisfies the predetermined threshold the process may discontinue iterating and output an aligned 3D projection of the object or a labeled image. In an instance in which the distance does not satisfy the predetermined threshold the process may continue iteration.

When the alignment process has been completed the UE 102 or image server 106 may generate and output a labeled image. The labeled image may include the 3D shape model landmark locations. The labeled image may be used for further digital processing, such as facial recognition, face tracking, face animation, 3D face modeling, or the like.

In an example embodiment, the UE 102 or image server 106 may integrate two or more 3D projections. The UE 102 or image server 106 may apply two or more regression models and generate two or more updates to the 3D projection. In some example embodiments, the UE 102 or image server 106 may determine inconsistent 3D projections. An inconsistent 3D projection may be a 3D shape model for which the distance between the 3D shape model landmark location and the true landmark location fails to meet a predetermined consistency threshold after at least one process iteration. For example, an inconsistent 3D projection may be determined in an instance in which the object position such as a face is significantly different from a true object position, such as a face looking left and an object position looking right based on 3D shape model and true landmark locations. In an instance in which the distance between 3D shape model landmark location and the true landmark location meets the predetermined consistency threshold, the 3D projection may be determined to be consistent.

In an instance in which an inconsistent 3D projection is determined, the inconsistent 3D projection may be removed from additional processing.

In an example embodiment, the UE 102 or the image server 106 may select two or more consistent 3D projection models and integrate, e.g. converge the 3D projection into a final 3D projection, from which the labeled image may be generated. The integration of the two or more consistent 3D projections may be an aggregation of the current landmark locations of the respective 3D projections.

### Example Apparatus

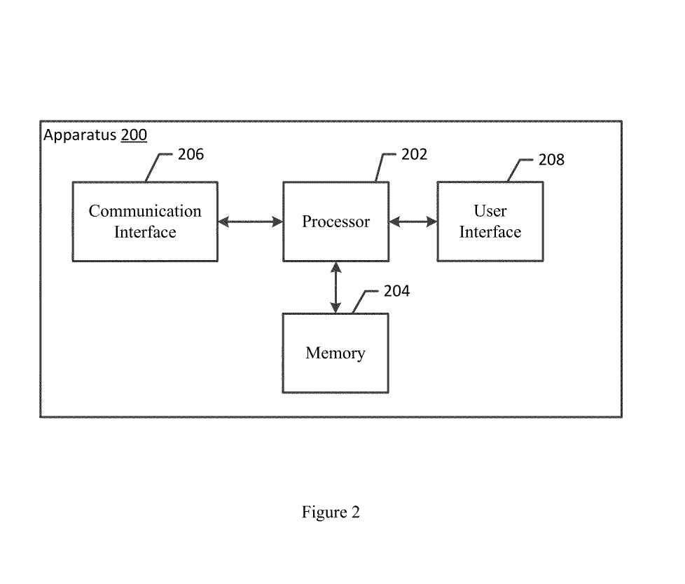

A UE 102 or image server 106 may include or otherwise be associated with an apparatus 200 as shown in FIG. 2. The apparatus, such as that shown in FIG. 2, is specifically configured in accordance with an example embodiment of the present invention for generating a labeled image based on an aligned three dimensional projection. The apparatus may include or otherwise be in communication with a processor 202, a memory device 204, a communication interface 206, and a user interface 208. In some embodiments, the processor (and/or co-processors or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (for example, a computer readable storage medium) comprising gates configured to store data (for example, bits) that may be retrievable by a machine (for example, a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

As noted above, the apparatus 200 may be embodied by UE 102 or image server 106. However, in some embodiments, the apparatus may be embodied as a chip or chip set. In other words, the apparatus may comprise one or more physical packages (for example, chips) including materials, components and/or wires on a structural assembly (for example, a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 202 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 202 may be configured to execute instructions stored in the memory device 204 or otherwise accessible to the processor. Alternatively or additionally, the processor may be configured to execute hard coded functionality. As such, whether configured by hardware or software methods, or by a combination thereof, the processor may represent an entity (for example, physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (for example, a mobile terminal or a fixed computing device) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The apparatus 200 of an example embodiment may also include a communication interface 206 that may be any means such as a device or circuitry embodied in either hardware or a combination of hardware and software that is configured to receive and/or transmit data from/to a communications device in communication with the apparatus, such as to facilitate communications with one or more user equipment 102, utility device, or the like. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware and/or software for supporting communication via cable, digital subscriber line (DSL), universal serial bus (USB) or other mechanisms.

The apparatus 200 may also include a user interface 208 that may, in turn, be in communication with the processor 202 to provide output to the user and, in some embodiments, to receive an indication of a user input. As such, the user interface may include a display and, in some embodiments, may also include a keyboard, a mouse, a joystick, a touch screen, touch areas, soft keys, one or more microphones, a plurality of speakers, or other input/output mechanisms. In one embodiment, the processor may comprise user interface circuitry configured to control at least some functions of one or more user interface elements such as a display and, in some embodiments, a plurality of speakers, a ringer, one or more microphones and/or the like. The processor and/or user interface circuitry comprising the processor may be configured to control one or more functions of one or more user interface elements through computer program instructions (for example, software and/or firmware) stored on a memory accessible to the processor (for example, memory device 204, and/or the like).

### Example Prior Art Facial Alignment Process

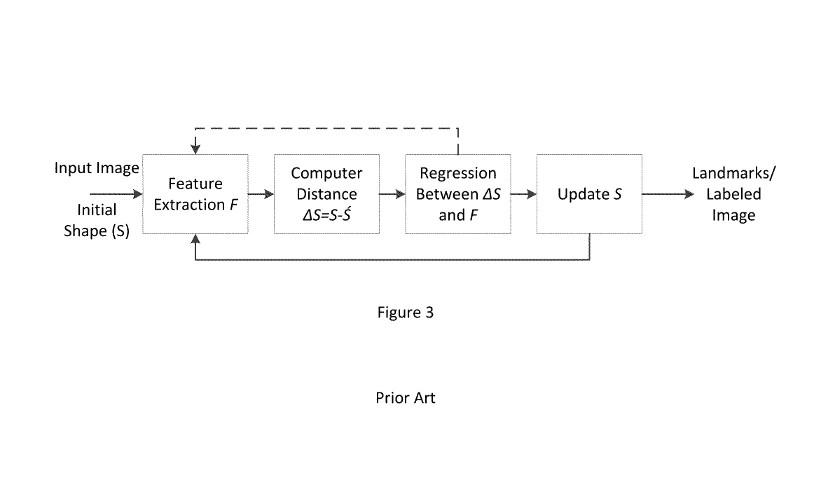

FIG. 3 illustrates an example prior art facial alignment process. The UE 102 or image server 106 may receive an input image and an initial shape (S). The UE 102 or image server 106 may perform feature extraction to determine a feature vector (F). The feature vector may be based on a pixel intensity and pixel location. The UE 102 or image server 106 may determine the distance (ΔS) between a current shape landmark location (S) and a ground truth landmark location (Ś).

ΔS=S−Ś

The ground truth location may be manually entered or a predicted landmark location.

The UE 102 or the image server 106 may apply a regression model based on the distance (ΔS) between the current shape landmark location and the ground truth location and the extracted feature (F). The UE 102 or image server 106 may update the shape current landmark location (S) based on the regression model output and generate a labeled image including the landmark locations.

In an example embodiment, the facial alignment process may iterate after updating the current shape landmark location, by returning to the feature extraction step one or more times. In some embodiments, the facial alignment process may iterate after the regression one or more time prior to updating the current location of the shape landmark locations.

### Example Object Alignment Process

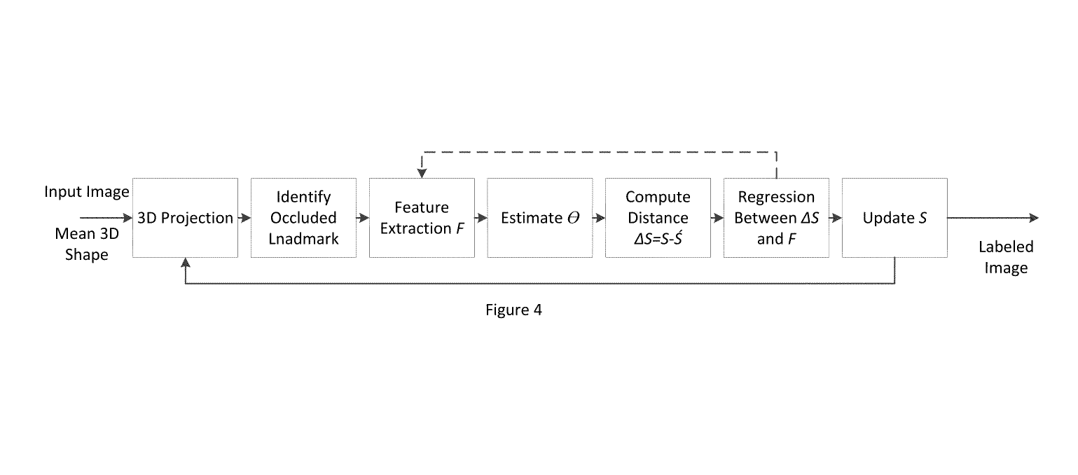

FIG. 4 illustrates an example object alignment process in accordance with an example embodiment of the present invention. The UE 102 or image server 106 may receive the input image, e.g. the 2D image, from a camera 104 or an image database 108. The UE 102 or image server 106 may also receive a mean 3D shape from an image database 108 or other memory. The UE 102 or image server 106 may generate a 3D projection by applying the input image to the 3D shape. In an example embodiment the input image may be applied to the 3D projection based on one or more correlated landmarks.

The UE 102 or image server 106 may identify occluded landmarks. The UE 102 or image server 106 may determine occluded landmarks by determining 3D projection landmarks that are not contained or not identified in the input image. The occluded landmarks may be removed from further processing steps.

The UE 102 or image server 106 may extract features from the 2D image and determine feature vectors (F). The feature vectors may be based on pixel intensity and location or other feature extraction methods, as discussed in conjunction with FIG. 1.

The UE 102 or image server 106 may estimate the object position (θ). In an example embodiment, the UE or image server may estimate an object position based on the non-occluded landmarks. For example right ear, nose, and right mouth corner, may indicate a face looking left. In some example embodiments, the UE 102 or image server 106 may iteratively determine the object position as discussed below in FIG. 5.

The UE 102 may compute the distance (ΔS) between the 3D shape model landmark location (S) and the true landmark location (Ś). The true landmark locations may be manually entered or a predicted location based on machine learning.

ΔS=S−Ś

The UE 102 may apply a regression model between the distance (ΔS) between the 3D shape model landmark locations (S) and the true landmark locations (S) and the feature vector (F). The regression model may be a non-parametric regression model, regression tree, or the like. The UE 102 or the image server 106 may update the 3D shape model landmark locations based on the regression model and output a labeled image. In an example embodiment, the regression model may be expressed as

y=2R(x)

where R is the regression model, and x is the input, e.g. the difference between ΔS 3DF.

In an example embodiment, the process may be iterative. The process may return to the 3D projection step following the update to the current shape model landmark locations. The process may iterate a predetermined number of times or iterate until the computed distance (ΔS) between the 3D shape model landmark location (S) and the true landmark location (S) satisfies a predetermined threshold.

In some example embodiments, the process may iterate following the regression model application to the feature extraction. In an instance in which the iteration is following the regression model application, the UE 102 or image server may output the labeled image after a predetermined number of iterations, or when the distance (ΔS) between the 3D shape model landmark location (S) and the true landmark location (Ś) satisfies a predetermined threshold.

### Example Object Position Alignment Process

FIG. 5 illustrates an example object position alignment process in accordance with an example embodiment of the present invention.

The UE 102 or image database 106 may estimate an object position. The object position may be the position of the object relative to the camera observation. For example, if the object, such as a human face, is looking directly at the camera the object position may be 0 degrees. In an instance in which the object in the input image is askew, the object pose may be one or more angles representing the divergence from a relative center, such as 30 degrees up, 10 degrees left, and 15 degrees clockwise rotation. In this example, the face may be tilted up 30 degrees, looking left 10 degrees, and cocked 15 degrees in a clockwise rotation from the relative center camera observation point. In an example embodiment, the object position estimate may start at 0 degrees in all directions and be aligned by iteration.

The UE 102 or image server 106 may compute a distance (AO) between an object position (θ) and a true object position (θ′).

Δθ=θ−θ′

The true object position may be manually entered, such as during a machine learning training stage, or a machine learned prediction, such as during an operation stage.

The UE 102 or image server 106 may apply a regression model, such as a non-parametric regression model or a regression tree between the distance (Δθ) between an object position (θ) and a true object position (θ′) and the feature vector (F).

The UE 102 or the image server 106 may update the object position of the 3D shape model based on the regression output. In some example embodiments, the object position alignment process may be iterative, such that the process repeats after the update of the 3D shape model based on the regression output. In an example embodiment, the object position alignment process may iterate a predetermined number of times, such as 2, 5, 10, or any other number of iterations. In some example embodiments, the object position alignment process may iterate until the distance (Δθ) between an object position (θ) and a true object position (θ′) satisfies a predetermined threshold, e.g. in an instance in which the difference between the object position and a true object position is negligible.

### Example Regression Forest

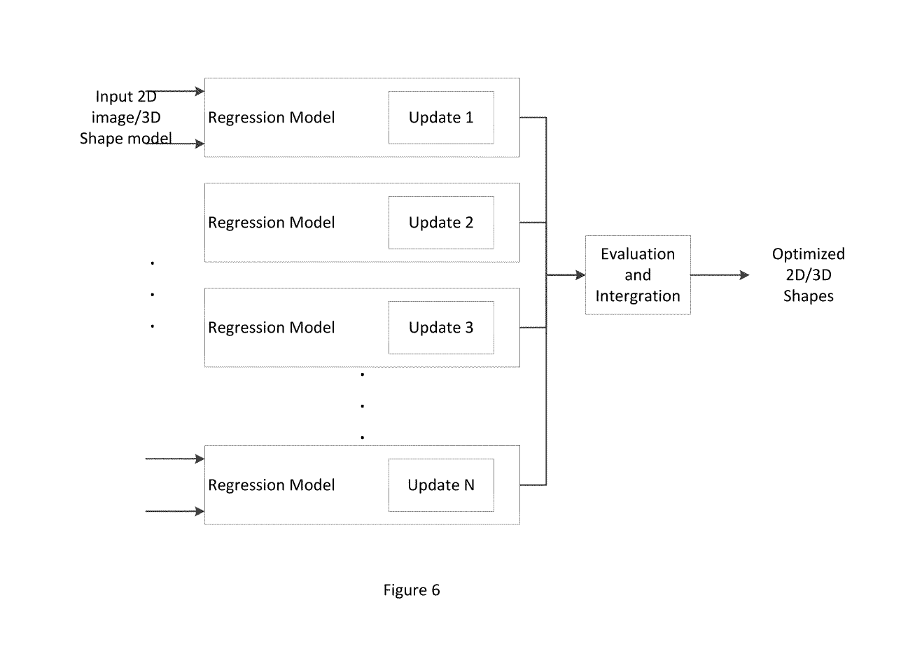

FIG. 6 illustrates an example regression forest in accordance with an embodiment of the present invention. During the training stage, the UE or image server 106 may generate a regression forest. The regression forest may be generated by training a set of cascading regression models. Each of the cascading regression models may be an object alignment process, as described in FIG. 4, in which the true object position and/or the true landmark locations are manually entered or machine learned predictions verified by a user.

In some example embodiments, the response variable, e.g. the number of landmarks, of the 3D shape model may be increased to generate a robust data set for machine learning. The robust data set may be beneficial during the operation stage to generate labeled images with invisible, e.g. occluded, landmarks and/or object position changes.

During the operation stage, the UE 102 or image server 106 may update the 2D alignment and the 3D shape models, of the cascaded regression model simultaneously. The true landmark locations of the 3D shape models may be a machined learned landmark location prediction. The 3D shape model may be redefined, e.g. updated, iteratively. In an example embodiment, the object position alignment may also be updated iteratively, such as concurrently with the iterative updates of the 3D shape model.

The UE 102 or image server 106 may detect and remove diverged, e.g. inconsistent, 3D shape models. In an example embodiment, the UE 102 or image server may integrate two or more consistent shape models into a final 3D shape model. The UE 102 or image server may generate the labeled image based on the final 3D shape model.

### Example Process for Generating a Labeled Image Based on a 3D Projection

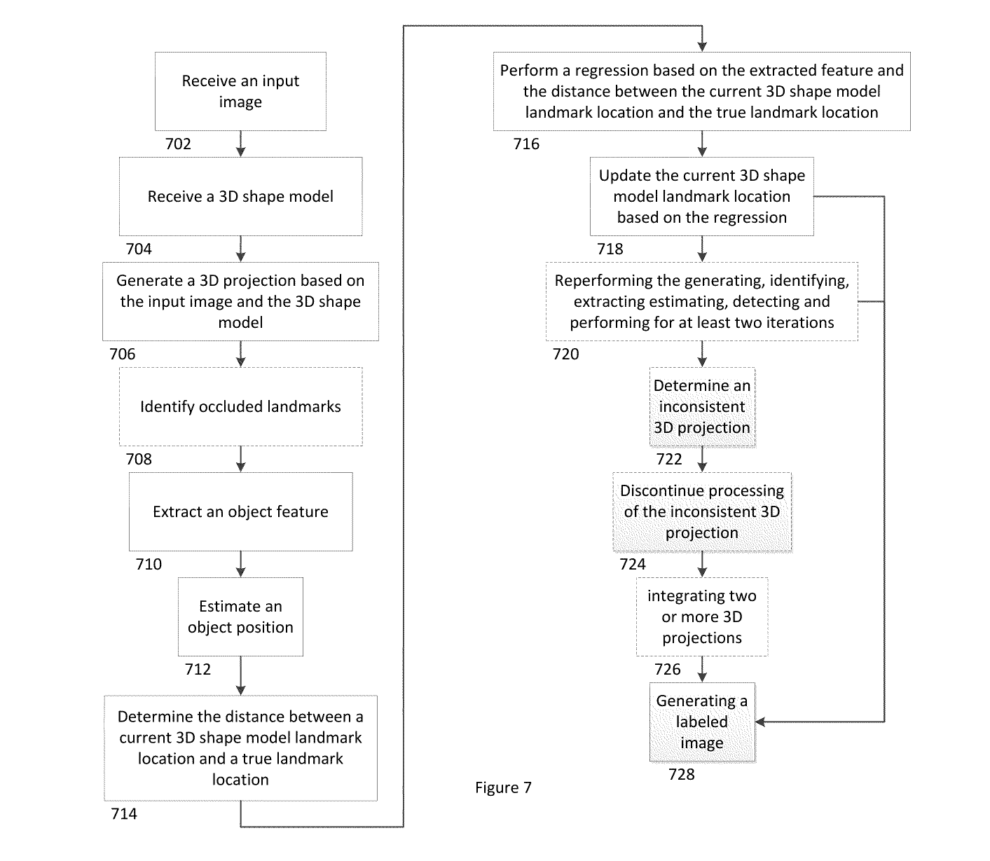

Referring now to FIG. 7, the operations performed, such as by the apparatus 200 of FIG. 2, for generating a labeled image based on a 3D projection are illustrated. As shown in block 702 of FIG. 7, the apparatus 200 may include means, such as a processor 202, memory 204, a communications interface 206, or the like, configured to receive a 2D input image. The processor 202 may receive the input image from the communications interface 206, which in turn, receives the two dimensional image from a camera, such as the camera 104, or memory 204, such as the image database 108. The input image may be a still picture, video frame, or the like depicting an object, such as a human face or inanimate object.

As shown in block 704 of FIG. 7, the apparatus 200 may include means, such as a processor 202, a memory 204, a communications module 206, or the like, configured to receive a 3D shape model. The processor 202 may receive the 3D shape model from the communications interface 206, which in turn, receives the 3D shape model from a memory 204, such as the image database 108. The 3D shape model may be associated with the object. The 3D shape model may be a mean shape based on an approximation of average measurements associated with the object class, for example average face dimensions.

As shown at block 706, of FIG. 7, the apparatus 200 may include means, such as a processor 202, or the like, configured to generate a 3D projection based on the input image and the 3D shape model. The processor 202 may generate the 3D projection by overlaying the input image on the 3D shape model. The processor 202 may overlay the 2D image on the 3D shape model based on correlating one or more landmarks.

As shown at block 708 of FIG. 7, the apparatus 200 may include means, such as a processor 202, or the like, configured to identify occluded landmarks. The process may identify occluded landmarks by determining landmarks associated with the 3D shape model which do not appear, are obscured, or cannot be identified, in the input image. The processor 202 may remove the occluded landmarks from further processing.

As shown at block 710 of FIG. 7, the apparatus 200 may include means, such as a processor 202, or the like, configured to extract an object feature. The processor 202 may extract one or more features from the input image generating a feature vector for the extracted feature. The feature vector may be based on the intensity and location of a pixel or other feature extraction methods, as discussed in FIG. 1.

As shown at block 712 of FIG. 7, the apparatus 200 may include means, such as a processor 202, or the like, configured to estimate an object position. The processor 202 may estimate an object position based on the non-occluded landmarks. For example right ear, nose, and right mouth corner, may indicate a face looking left. The processor 202 may compute a distance between an object position and a true object position. The true object position may be manually entered, such as during a machine learning training stage, or a machine learned prediction, such as during an operation stage. The processor 202 may apply a regression model, such as a non-parametric regression model or a regression tree between the distance between an object position and a true object position and the feature vector. The processor 202 may update the object position of the 3D shape model based on the regression output.

In some example embodiments, the object position alignment process may be iterative, such that the process repeats after the update of the 3D shape model based on the regression output. In an example embodiment, the object position alignment process may iterate a predetermined number of times, such as 2, 5, 10, or any other number of iterations. In some example embodiments, the object position alignment process may iterate until the distance between an object position and a true object position satisfies a predetermined threshold, e.g. in an instance in which the difference between the object position and a true object position is negligible.

In an example embodiment, the object position may be approximated based on landmarks identified in the 2D image and then iteratively aligned to further refine the object position alignment.

As shown at block 714 of FIG. 7, the apparatus 200 may include means, such as a processor 202, user interface 208, or the like, configured to determine the distance between a 3D shape landmark location and a true landmark location. The true landmark location may be entered manually using a user interface, such as user interface 208, or be a machine learned landmark location prediction.

As shown at block 716 of FIG. 7, the apparatus 200 may include means, such as a processor 202, or the like, configured to apply a regression model between the extracted feature and the distance between the 3D shape model landmark location and the true landmark location. The regression model may be a non-parametric regression model, a regression tree, or the like.

As shown at block 718 of FIG. 7, the apparatus 200 may include means, such as a processor 202, or the like, configured to update the 3D shape model landmark location based on the regression. The process may continue at block 720 or block 728.

As shown at block 720 of FIG. 7, the apparatus 200 may include means, such as a processor 202, or the like, configured to reperform blocks 706 through 718 for at least two iterations. In an example embodiment, the processor 202 may iterate blocks 706 through 718 for a predetermined number of iterations such as 2, 3, 10, or any other number of iterations. In some example embodiments, the processor may compare the distance between the 3D shape object landmark location to a predetermined threshold value each iteration. In an instance in which the processor 202 determines that the distance satisfies the predetermined threshold, such as the distance is negligible, the process may discontinue iterations. In an instance in which the processor 202 determines that the distance fails to satisfy the predetermined threshold, the process may continue iterations. The process may continue at block 722 or block 728.

Additionally or alternatively, the processor 202 may iterate blocks 710 through 716, in a manner substantially similar to the iteration of blocks 706-718 and proceed to block 718 when the iteration process is complete.

As shown at block 722 of FIG. 7, the apparatus 200 may include means, such as a processor 202, user interface 208, or the like, configured to determine inconsistent 3D projections. In an example embodiment, the processor may build a regression tree based on each iteration of the alignment process, e.g. blocks 706-718. The processor 202 may determine an inconsistent 3D projection by comparing 3D shape model and true landmark locations. In an instance in which the difference between the 3D shape model landmark locations and the true landmark locations satisfy a predetermined consistency threshold the 3D projection may be determined as consistent. In an instance in which, the distance between the 3D shape model fails to satisfy the predetermined consistency, the processor 202 may determine the 3D projection to be inconsistent.

Additionally or alternatively, a 3D projection may be determined to be inconsistent by a manual entry, such as on a user interface 208. Manual entry of inconsistent 3D projections may be performed, for example, during a training stage.

As shown at block 724 of FIG. 7, the apparatus 200 may include means, such as a processor 202, or the like, configured to discontinue processing of inconsistent 3D projections.

As shown in block 726 of FIG. 7, the apparatus 200 may include means, such as a processor 202, or the like, configured to integrate two or more 3D projections. The processor 202 may integrate two or more consistent 3D projections into a single 3D projection of the object. The integration of the two or more consistent 3D projections may be an aggregation of the 3D shape landmark locations for the respective 3D projections.

As shown in block 728 of FIG. 7, the apparatus 200 may include means, such as a processor 202 to generate a labeled image. The labeled image may be the input image with the updated 3D projection landmark locations. The labeled image may be utilized by object recognition, tracking, animation and modeling application, such as facial recognition, tracking animation and modeling.

Generation of a labeled image based on the aligned 3D projection may allow for a robust and accurate face alignment for object recognition, tracking, animation, modeling, or other applications. Further, generation of the labeled image based on the aligned 3D projection may allow for accurate alignment and labeling in unconstrained environments, such as variant objects, e.g. facial, appearance, illumination, and partial occlusions.

As described above, FIGS. 4-7 illustrate flowcharts of an apparatus 200, method, and computer program product according to example embodiments of the invention. It will be understood that each block of the flowcharts, and combinations of blocks in the flowcharts, may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 204 of an apparatus employing an embodiment of the present invention and executed by a processor 202 of the apparatus. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included, such as illustrated by the dashed outline of block 708, 720, 722, 724, and 726 in FIG. 7. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
receiving an input image and a three dimensional (3D) shape model associated with an object;
generating a 3D projection based on the input image and the 3D shape model;
extracting object features associated with a landmark location from the input image;
estimating an object position based on the extracted features;
determining a distance between a current 3D shape landmark location and a true landmark location;
applying a regression model based on the extracted feature and the distance between the 3D shape landmark location and the true landmark location;
updating the 3D shape model landmark location of the 3D projection based on the regression; and
generating a labeled image based on the updated 3D projection.

2. The method of claim 1 further comprising:
reperforming the generating, identifying, extracting, estimating, detecting, and applying for at least two iterations.

3. The method of claim 2 further comprising:
determining an inconsistent 3D projection; and
discontinuing possessing of the inconsistent 3D projection.

4. The method of claim 2 further comprising:
integrating two or more 3D projections.

5. The method of claim 1, wherein the estimating an object position further comprises:
determining a distance between an object position of the 3D projection and a true object position;
performing a regression between the extracted features and the distance between the object position of the 3D projection and the true object position; and
updating the object position of the 3D projection.

6. The method of claim 5 further comprising:
reperforming the determining the distance between the object position of the 3D projection and the true object position, performing the regression between the extracted feature and the distance between the object position of the 3D projection and the true object position, and updating the object position of the 3D projection for at least two iterations.

7. The method of claim 1 further comprising:
identifying occluded landmarks associated with the 3D projection; and
discontinuing processing of the occluded landmarks.

8. An apparatus comprising at least one processor and at least one memory including computer program code, the at least one memory and computer program code configured to, with the processor, cause the apparatus to at least:
receive an input image and a three dimensional (3D) shape model associated with an object;
generate a 3D projection based on the input image and the 3D shape model;
extract object features associated with a landmark location from the input image;
estimate an object position based on the extracted features;
determine a distance between a 3D shape landmark location and a true landmark location;
apply a regression model based on the extracted feature and the distance between the 3D shape landmark location and the true landmark location;
update the 3D shape model landmark location of the 3D projection based on the regression; and
generate a labeled image based on the updated 3D projection.

9. The apparatus of claim 8, wherein the at least one memory and the computer program code are further configured to:
reperform the generating, identifying, extracting, estimating, detecting, and applying for at least two iterations.

10. The apparatus of claim 9, wherein the at least one memory and the computer program code are further configured to:
determine an inconsistent 3D projection; and
discontinue possessing of the inconsistent 3D projection.

11. The apparatus of claim 9, wherein the at least one memory and the computer program code are further configured to:
integrate two or more 3D projections.

12. The apparatus of claim 8, wherein the estimating an object position further comprises:
determining a distance between an object position of the 3D projection and a true object position;
performing a regression between the extracted features and the distance between the object position of the 3D projection and the true object position; and
updating the object position of the 3D projection.

13. The apparatus of claim 12, wherein the at least one memory and the computer program code are further configured to:
reperform the determining the distance between the object position of the 3D projection and the true object position, performing the regression between the extracted feature and the distance between the object position of the 3D projection and the true object position, and updating the object position of the 3D projection for at least two iterations.

14. The apparatus of claim 8, wherein the at least one memory and the computer program code are further configured to:
identify occluded landmarks associated with the 3D projection; and
discontinue processing of the occluded landmarks.

15. A computer program product comprising at least one non-transitory computer-readable storage medium having computer-executable program code portions stored therein, the computer-executable program code portions comprising program code instructions configured to:
receive an input image and a three dimensional (3D) shape model associated with an object;
generate a 3D projection based on the input image and the 3D shape model;
extract object features associated with a landmark location from the input image;
estimate an object position based on the extracted features;
determine a distance between a 3D shape landmark location and a true landmark location;
apply a regression model based on the extracted feature and the distance between the 3D shape landmark location and the true landmark location;
update the 3D shape model landmark location of the 3D projection based on the regression; and
generate a labeled image based on the updated 3D projection.

16. The computer program product of claim 15, wherein the computer-executable program code portions further comprise program code instructions configured to:
reperform the generating, identifying, extracting, estimating, detecting, and applying for at least two iterations.

17. The computer program product of claim 16, wherein the computer-executable program code portions further comprise program code instructions configured to:
determine an inconsistent 3D projection; and
discontinue possessing of the inconsistent 3D projection.

18. (canceled)

19. The computer program product of claim 15, wherein the estimating an object position further comprises:
determining a distance between an object position of the 3D projection and a true object position;
performing a regression between the extracted features and the distance between the object position of the 3D projection and the true object position; and
updating the object position of the 3D projection.

20. The computer program product of claim 19, wherein the computer-executable program code portions further comprise program code instructions configured to:
reperform the determining the distance between the object position of the 3D projection and the true object position, performing the regression between the extracted feature and the distance between the object position of the 3D projection and the true object position, and updating the object position of the 3D projection for at least two iterations.

21. The computer program product of claim 15, wherein the computer-executable program code portions further comprise program code instructions configured to:
identify occluded landmarks associated with the 3D projection; and
discontinue processing of the occluded landmarks.

22-28. (canceled)
